(19) United States
(12) Patent Application Publication
(10) Pub. No.: US 2006/0271970 A1
(43) Pub. Date: Nov. 30, 2006

(54) Apparatus and method for transmitting information between seats in a mobile platform using an existing power line

(76) Inventors: Bradley J. Mitchell, Snohomish, WA (US); Kevin S. Callahan, Shoreline, WA (US)

Correspondence Address: HARNESS, DICKEY & PIERCE, P.L.C., P.O. BOX 828, BLOOMFIELD HILLS, MI, 48303, US

(21) Appl. No.: 11/130,549

(22) Filed: May 17, 2005

(51) Int. Cl. H04N 7/18

(52) U.S. Cl. 725/82; 725/76; 725/74

(57) ABSTRACT

A system and method for transmitting an audio portion of information received at a first seat on a mobile platform to an adjacent second seat, over pre-existing power lines supplying power to various electronic components of both the first and second seats. An encoder subsystem generates a high frequency, encoded signal that is inductively superimposed onto the power signal on the power lines by a first coupling subsystem. The coupling subsystem includes a high pass filter and an inductive coupling element. At the second seat the superimposed signal is inductively sensed by a second coupling subsystem associated with the second seat, and transmitted to a decoder subsystem associated with the second seat. The decoder subsystem decodes the encoded electrical signal and transmits it to an audio jack on the second seat. Thus, an occupant seated in the second seat can listen to audio content while viewing video content displayed on a video display unit supported from a seatback portion of the first seat. Advantageously, no additional electrical cabling is needed to accomplish the feedback of the audio signal from the first seat to the second seat.

### CROSS-REFERENCE TO RELATED APPLICATIONS

The subject matter of the present application is generally related to the subject matter of U.S. application Ser. No. ______ (Boeing Docket 04-1186), entitled “Wireless Transmission of Information Between Seats In a Mobile Platform Using Magnetic Resonance Energy”, filed concurrently herewith, the subject matter of which is also incorporated by reference into the present application.

### FIELD OF THE INVENTION

The present invention relates to apparatuses and methods for transmitting information between seats in a mobile platform, and more particularly to a method and apparatus for transmitting audio or video information between passenger seats over an existing power line to which both seats are coupled.

### BACKGROUND OF THE INVENTION

On various forms of mobile platforms, and particularly on commercial aircraft, In-Flight Entertainment (IFE) systems are required to send video streams to an aircraft passenger's video display unit, and synchronized audio streams to a headphone jack in a passenger's PCU (Passenger Control Unit) or to some other audio speaker. Typically, the video display is located in the seatback of a first seat disposed in a first seat row. The audio signal that is associated with the video content displayed on the video display, however, typically needs to be supplied to an audio jack or speaker that is located in a second seat of a second seat row directly behind the first seat. Thus, the video and audio streams must be delivered to two separate network “clients”, but still played in near-perfect synchronization. This is considerably different than the typical network or internet situation where the video and sound signals are played on the same client/host apparatus.

In the past, IFE systems have generally been hardwired systems. The audio and video signals have been delivered as analog or digital signals to one or the other of the first or second seats described above. Feedforward or feedback cables have been used to send the analog signal to the “other half” of the client. For example, if the analog and video signals were delivered to the first seat, then feedforward or feedback cables were used to supply just the audio analog signal to the audio jack or speaker associated with the second seat. With this scheme, synchronization is not a problem.

It would be highly desirable to be able to transmit information, and particularly either audio or video information, between two adjacently located seat groups over pre-existing conductors that are associated with the seats that supply power to other pre-existing components located on the seats. This would eliminate the need for additional, dedicated wiring to be used between the two seat groups just to handle the audio or video signals that are fed back (or fed forward) from one seat group to the other.

### SUMMARY OF THE INVENTION

The present invention is directed to a system and method for transmitting information between adjacent passenger seat groups. In one preferred implementation, the present invention involves a system for transmitting information from a first seat to a second seat over a pre-existing power line that both seats are interfaced to. In this implementation an encoder is used to encode the information onto the power lines connecting the two seat groups. The encoded information has a different frequency than the frequency of the power signal being transmitted over the power lines to which the two seats are coupled. The encoded information is output to a first coupling subsystem that superimposes the encoded information, as an encoded signal, onto the power signal being conducted on the power lines. The superimposed, encoded signal flows through the power lines from the first seat towards the second seat. A coupling subsystem associated with the second seat inductively couples the encoded signal from the power lines into a decoder subsystem. The decoder subsystem decodes the encoded signal and transmits it to a port or other subsystem that is usable by an occupant of the second seat.

In one preferred implementation at least one filter is disposed in the power lines in a location adjacent the first seat to limit the propagation on the power lines of the encoded signal to one direction only, that direction being toward the second seat. In this implementation a second filter is also disposed in the power lines adjacent the second seat to prevent the propagation of the encoded signal along the power lines past the location of the second seat.

In one preferred implementation, the encoded signal represents audio information that is received via a wireless RF signal at a receiver located on the first seat. In this implementation the wireless RF signal includes both audio and video information. The video information is output to a separate video display unit located on a seatback portion of the first seat facing rearwardly toward the second seat.

In another preferred implementation the coupling subsystem employed on each of the first and second seats comprises a high pass filter and an inductive coupling element. The high pass filter blocks the power signal from being coupled into the encoder subsystem located on the first seat, or into the decoder subsystem located on the second seat.

In still another implementation, each of the first and second seats includes both an encoder subsystem, a decoder subsystem, and a pair of coupling subsystems. One of the coupling subsystems interfaces the decoder subsystem to the power line while the other coupling subsystem interfaces the encoder subsystem to the power line. Each of the coupling subsystems includes a high pass filter and allows electrical signals to flow in one direction only, i.e., either from the power line into the decoder subsystem, or from the encoder subsystem out on to the power line. In this implementation a low pass filter is disposed in the power line in series in between the points where the two coupling subassemblies interface to the power line. The low pass filter blocks the propagation of the encoded signal toward the first seat such that the signal can only propagate toward a third seat located adjacent to the second seat, which is also interfaced to the power line.

The various preferred embodiments eliminate the need for including additional electrical cabling between the first and second seats in order to provide information, for example an audio or video signal, to the second seat that needs to be synchronized with information being supplied to the first seat.

The features, functions, and advantages can be achieved independently in various embodiments of the present inventions or may be combined in yet other embodiments.

### BRIEF DESCRIPTION OF THE DRAWINGS

The present invention will become more fully understood from the detailed description and the accompanying drawings, wherein:

FIG. 1 is a simplified view of a mobile platform, in this example a commercial aircraft, incorporating a system in accordance with a preferred embodiment of the present invention, and also illustrating a typical in-flight entertainment system that may be employed on the aircraft; and

FIG. 2 is a simplified perspective view of two seat rows within the mobile platform of FIG. 1 illustrating an implementation of a preferred embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

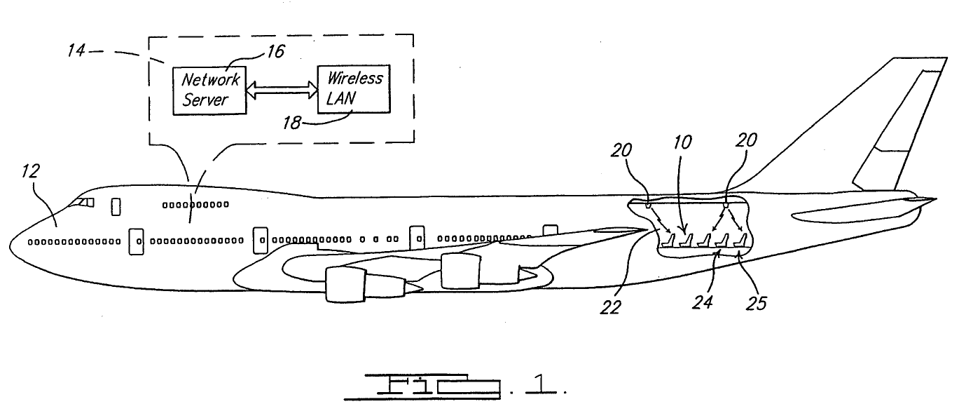

Referring to FIG. 1, there is shown a system 10 for transmitting information between adjacent seats in a mobile platform 12. In this example, the mobile platform is illustrated as a commercial aircraft, but it will be appreciated that the system 10 can be implemented in virtually any other form of mobile platform, such as a ship, bus, train or rotorcraft. Also, the system 10 is not limited to use on mobile platforms, but could just as readily be employed in terrestrial structures such as auditoriums, lecture halls, theatres, etc.

In this example the aircraft 12 includes an in-flight entertainment (IFE) system 14. The IFE system 14 typically includes a network server 16 having information content stored thereon, that is in communication with a wireless local area network (LAN) 18. The wireless LAN 18 transmits wireless RF signals to a plurality of access points 20 typically located in an overhead portion in the aircraft 12 and spaced apart at points along a cabin area 22 of the aircraft 12. The wireless access points 20 relay wireless RF signals to a plurality of seats located within a plurality of seat rows within the aircraft 12. Two such seat rows have been designated with reference numerals 24 and 25. Typically each seat row includes two or more seats. The wireless RF signals can relate to movies or other types of information content.

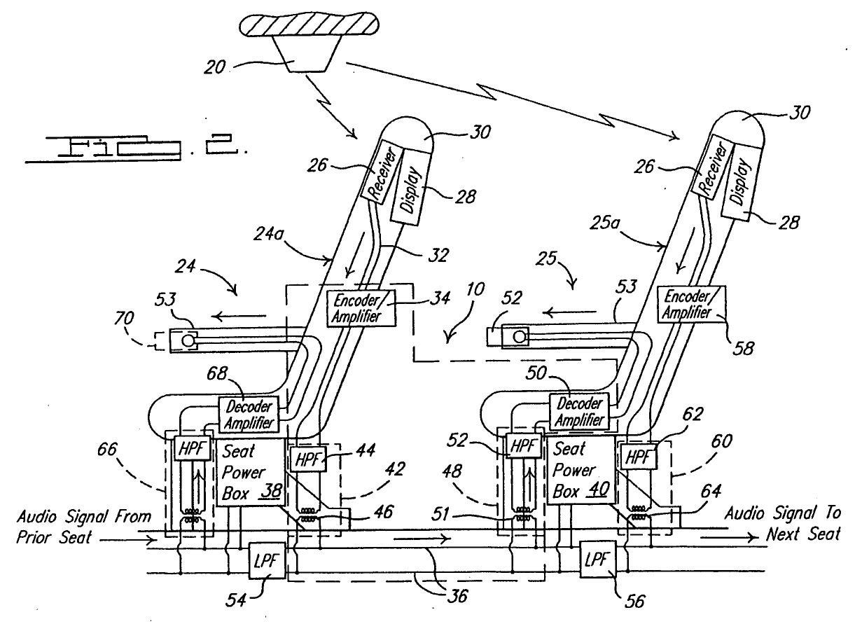

Referring now to FIG. 2, one seat in each seat row 24 and 25 is illustrated, and the two seats are designated as seats 24A and 25A. Seat 25A is located directly behind seat 24A, and seats 24A and 25A thus form a seat “pair”. Again, it will be appreciated that since typically more than one seat is located in each seat row, there will typically be several such seat “pairs” formed between the seats in rows 24 and 25. Each seat pair is made up of one seat in row 25 and the seat in row 24 that is directly in front of it.

In one preferred implementation the system 10 is used to “feedback” audio information from the wireless RF signal transmitted from the access point 20, which is received by the first seat 24A, to the second seat, 25A. This is accomplished by the use of an RF receiver 26 that is located on the first seat. The RF receiver 26 receives both audio and video components of the wireless RF signal transmitted from the wireless access point 20 and provides the video portion to a video display unit 28. The video display unit 28 is typically mounted on a rear surface of a seat back portion 30 of seat 24A so that it faces the second seat 25A immediately behind it. The audio portion of the information received by the receiver 26 is provided via conductors 32 to an encoder subsystem formed by an encoder/amplifier subsystem 34 of the system 10. The encoder/amplifier subsystem 34 generates encoded electrical signals having a different frequency from the power signals transmitted along a pair of power lines 36 that are interfaced to each seat row 24 and 25. Typically the power lines 36 are disposed within or adjacent to a track on which each of the seats in seat rows 24 and 25 are mounted. The power lines 36 supply electrical power to various electronic components and subassemblies associated with each seat 24A and 25A via a seat power box 38 (for seat 24A) and seat power box 40 (for seat 25A). In one preferred implementation the encoded electrical signals are of a higher frequency, and more preferably a significantly higher frequency, than the frequency of the power signal that is transmitted through the power lines 36. In one preferred form the frequency of the encoded electrical signals generated by the encoder/amplifier subsystem 34 is preferably in the range of between about 50-140 kHz.

With further reference to FIG. 2, the system 10 includes a coupling subsystem 42 comprised of a high pass filter 44 and an inductive coupling element 46. The high pass filter 44 allows the higher frequency encoded electrical signals generated from the encoder/amplifier subsystem 34 to pass through it where they are inductively superimposed by the inductive coupling element 46 onto the power lines 36. The encoded electrical signals propagate along the power lines 36 toward the second seat 25A and are coupled by a second coupling subsystem 48 to a decoder subsystem 50. The coupling subsystem 48 is identical to coupling subsystem 42 and includes an inductive coupling element 51 and a high pass filter 52. The inductive coupling element 51 inductively couples the higher frequency encoded electrical signals from the power lines 36 into the high pass filter 52. The high pass filter 52 blocks the propagation of the lower frequency power signal transmitted over the power lines 36 from reaching the decoder subsystem 50, while allowing the encoded electrical signals to pass through into the decoder subsystem 50.

The decoder subsystem 50, in one implementation, is formed by a decoder/amplifier subsystem that decodes and amplifies the encoded electrical signals back into a usable form to be accessed via a user accessible subsystem 52, such as an audio jack. The audio jack typically forms a portion of a passenger control unit (PCU) mounted in an armrest 53 of the seat 25A. Thus, the occupant of the second seat 25A can couple a headset into the subsystem 52 and receive the audio portion of program content while the video portion of the same program content is being displayed on the video display 28 immediately in front of him/her.

The system 10 thus enables a desired portion of the information received at the receiver 26 to be “fed back” from one seat to a different seat over the pre-existing power lines 36 in the floor of the aircraft 12. Accordingly, no additional electrical cabling needs to be installed between seats 24A and 25A to accomplish the routing and transmission of only a desired portion of information content to the second seat. This significantly reduces the electrical cabling required between the seats, which in turn reduces the overall weight of the mobile platform, as well as the complexity of the installation of an in-flight entertainment system on a mobile platform. This also reduces the overall cost of implementing such a system. Also importantly, the system 10 enables the audio portion of program content to be played back by the occupant of seat 25A in synchronization with the video signal being displayed on the video display unit 28.

With further reference to FIG. 2, in a preferred implementation at least one low pass filter 54, and more preferably a pair of low pass filters 54 and 56, are coupled in series with the power lines 36. Low pass filter 54 allows the lower frequency power signal to propagate through it along the power lines 36, but blocks the propagation of the higher frequency encoded electrical signals generated by encoder 34. Thus, the encoded electrical signals coupled onto the power lines 36 by inductive coupling element 46 are only allowed to propagate toward the second seat 25A. Similarly, low pass filter 56 allows the lower frequency power signal to propagate through it on the power lines 36. Thus, there is no interruption of the lower frequency electrical power signal that is propagating along power lines 36, as this signal is fed to each seat row on the aircraft 12. Low pass filter 56, however, prevents the propagation of encoded electrical signals generated by an encoder/amplifier subsystem 58, which are coupled onto the power line by coupling assembly 60, from propagating towards the first seat 24A. Coupling subassembly 60 is identical in construction to coupling subassemblies 42 and 48, and includes a high pass filter 62 and an inductive coupling element 64. The low pass filter 56 thus allows an encoded electrical signal from encoder/amplifier subsystem 58, that is coupled onto the power lines 36, to propagate only to the right in the drawing of FIG. 2 along the power lines 36.

With further reference to FIG. 2, the first seat 24A also preferably includes an additional coupling subassembly 66, an additional decoder/amplifier system 68 and an additional user accessible subassembly 70, for example, a PCU having an audio jack. Subsystems 66, 68 and 70 are identical in construction to subsystems 48, 50 and 52, respectively, of the second seat 25A. Thus, each seat 24A, 25B is able to both receive encoded electrical signals from the power lines 36, as well as to superimpose encoded electrical signals onto the power lines 36. Low pass filter 54 blocks the propagation of encoded electrical signals traveling on the power lines 36 from the left of seat 24A in the drawing in FIG. 2, so that these signals can only be used by seat 24A after being coupled into the decoder subsystem 68 by the coupling subsystem 66.

In practice, when a plurality of adjacent seat pairs are formed one next to the other, such as typically is the case on a mobile platform, each encoder/amplifier subsystem 34, 58 will typically use a slightly different encoding scheme than the scheme used for the seat immediately next to it. This ensures that the encoded electrical signals placed on the power lines 36 from encoder/amplifier subsystem 34 at seat 24A are only able to be decoded by decoder subsystem 50 of seat 25A. Put differently, there is no possibility of one or more seats positioned in the same seat row 25 adjacent seat 25A from receiving and decoding the encoded electrical signal from seat 24A. Alternatively, signals from the receivers 26 of a plurality of seats in a seat row 24 may be multiplexed together at a single encoder/amplifier 34 in the seat row 24 and then de-multiplexed at a single decoder/amplifier 50 in the seat row 25 for access via the user accessible subsystems 52, such as audio jacks.

It will also be appreciated that instead of feeding back encoded signals from seat 24A to seat 25A, that the above described implementation could be reversed so that specific information could be “fed forward” from seat 25A to seat 24A. For example, information from the wireless access point 20 could be received by seat 25A through a receiver located on seat 25A, and the video portion of this signal could be coupled onto the power lines 36 and fed forward for use on the video display unit 28 of seat 24A.

The various preferred embodiments described above can also be used to couple other forms of information between the two seats 24A and 25A. Such other information could include, for example, reading light commands (e.g., such as a button on forward seat 24A controlling a light mounted on aft seat 25A). Another example is a synchronization signal to synchronize audio being provided at the aft seat 25A with video content being displayed from the forward seat 24A. In this example, controllers for both the fore and aft seats 24A and 25A, respectively, decode the appropriate data from the wireless data stream received from the wireless access points 20 based on the time shared synchronization signal. The synchronization between seats 24A and 25A can be maintained using a simple timing signal coupled onto the power lines as before. This timing signal is issued by the “master” client where the master client is arbitrarily defined as the first seat controller. The “slave” client will use this synchronization signal to delay playback of the audio to match the visual display at the master.

While various preferred embodiments have been described, those skilled in the art will recognize modifications or variations which might be made without departing from the inventive concept. The examples illustrate the invention and are not intended to limit it. Therefore, the description and claims should be interpreted liberally with only such limitation as is necessary in view of the pertinent prior art.
What is claimed is:

1. A system for transmitting information from a first seat on a structure to a second seat on the structure over a preexisting power line supplying electrical power to electronic components located on each of said first and second seats, the system comprising:
an encoder associated with said first seat for encoding said information into an encoded electrical signal, said encoded electrical signal having a frequency different from a line frequency of a power signal being transmitted over said preexisting power line coupled to said seats;
a first electrical subsystem associated with said first seat for inductively superimposing said encoded electrical signal onto said power signal on said preexisting power line while blocking said power signal from interfering with said first electrical subsystem;
a second electrical subsystem associated with said second seat and interfaced with said preexisting power line, for inductively receiving said encoded electrical signal from said preexisting power line while blocking said power signal from interfering with said second electrical subsystem; and
a decoder associated with said second seat and being responsive to said second electrical subsystem, for decoding said encoded electrical signal to provide said information, said information being useable by an occupant of said second seat.

2. The system of claim 1, further comprising a radio frequency (RF) receiver associated with said first seat for receiving a wireless signal containing said information.

3. The system of claim 2, wherein said encoder comprises an amplifier for amplifying said encoded electrical signal.

4. The system of claim 1, wherein said first electrical subsystem comprises a high pass filter.

5. The system of claim 1, wherein said second electrical subsystem comprises a high pass filter.

6. The system of claim 1, wherein said first electrical subsystem comprises an inductive coupling component interfaced to said preexisting power line.

7. The system of claim 1, wherein said second electrical subsystem comprises an inductive coupling component interfaced to said preexisting power line.

8. The system of claim 1, further comprising a low pass filter coupled in series with said preexisting power line adjacent said first electrical subsystem for preventing the transmission of said encoded electrical signal in a second direction on said preexisting power line away from said second seat, while allowing a propagation of said encoded electrical signal along said preexisting power line toward said second seat.

9. The system of claim 1, wherein said encoded electrical signal comprises an encoded audio signal.

10. A system for transmitting information from a first seat on a structure to a second seat on the structure over a preexisting power line supplying electrical power to electronic components located on each of said first and second seats, the system comprising:
an encoder associated with said first seat for encoding said information into an encoded electrical signal, said encoded electrical signal having a frequency higher than a line frequency of a power signal being transmitted over said preexisting power line coupled to said seats;
a first coupling subsystem associated with said first seat for inductively coupling said encoded electrical signal onto said preexisting power line while blocking said power signal from propagating into said encoder;
a second coupling subsystem associated with said second seat and interfaced with said preexisting power line, for inductively receiving said encoded electrical signal from said preexisting power line while blocking said power signal; and
a decoder associated with said second seat and being responsive to said second coupling subsystem, for decoding said encoded electrical signal to provide said information in usable form to an occupant of said second seat.

11. The system of claim 10, wherein said information comprises one of audio signals and video signals.

12. The system of claim 11, further comprising a radio frequency (RF) receiver associated with said first seat for receiving said information in wireless form.

13. The system of claim 11, further comprising a video display unit associated with said first seat for displaying video signals to said occupant of said second seat simultaneously and in synchronization with the encoded electrical signal transmitted to seat second seat over said power line.

14. The system of claim 10, further comprising a low pass filter coupled in series with said preexisting power line for blocking a propagation of said encoded electrical signal along said power line in a direction away from said second seat.

15. The system of claim 10, wherein said encoded electrical signal has a frequency with a range of about 50 kHz-140 kHz.

16. The system of claim 10, wherein said second seat includes an encoder and a second coupling subsystem, said second coupling subsystem being in communication with said power line for enabling an additional encoded electrical signal to be inductively coupled onto said power line, while blocking a propagation of said power signal toward said encoder of said second seat.

17. A method of transmitting information from a first seat on a structure to a second seat on a structure over a power line coupled to each of the seats, in which the power line is supplying electrical power to at least one electronic component located on each said seat, the method comprising:
at said first seat, generating an encoded electrical signal representative of said information, and wherein the encoded electrical signal has a frequency different from that of said electrical power being transmitted over said power line;
superimposing said encoded electrical signal on to said power line through a first electrical subsystem;
using said power line to conduct said encoded electrical signal toward said second seat;
coupling said encoded electrical signal from said power line to a decoder associated with said second seat; and
using said decoder to decode said encoded electrical signal back into an output signal useable by an occupant of said second seat.

18. The method of claim 17, wherein said information comprises one of audio and video information.

19. The method of claim 17, further comprising using at least one additional filter in said power line to limit propagation of said encoded electrical signal in one direction only along said power line.

20. The method of claim 17, further comprising wirelessly transmitting radio frequency signals to said first seat, and from said radio frequency signals, extracting said information.
